(19) United States
(12) Patent Application Publication
(10) Pub. No.: US 2010/0008440 A1
(43) Pub. Date: Jan. 14, 2010

(54) LINK ADAPTATION IN WIRELESS COMMUNICATIONS

(75) Inventors: Hsin-Piao Lin, Taoyuan City (TW); Rong-Terng Juang, Erlin Township (TW); Pang-An Ting, Fongyuan City (TW); Chun-Lin Yeh, Hsinchu City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Industrial Technology Research Institute

(21) Appl. No.: 12/366,400

(22) Filed: Feb. 5, 2009

Related U.S. Application Data
(60) Provisional application No. 61/079,101, filed on Jul. 8, 2008.

(51) Int. Cl. H04B 7/02

(52) U.S. Cl. 375/267

(57) ABSTRACT

A wireless communication system with link adaptation is provided. The wireless communication system may include a channel k-factor estimator estimating a Rician k-factor of a channel based on a signal received from a transmitter, a frequency band grouping unit determining a size of frequency band grouping based on the Rician k-factor, a transmission mode selector determining a transmission mode for each frequency band group based on the Rician k-factor, and a modulation and coding scheme selector determining a modulation and coding scheme for the each frequency band group.

### I. PRIORITY

This application claims the benefit of priority of U.S. Provisional Application No. 61/079,101, filed Jul. 8, 2008, which is incorporated by reference herein in its entirety for any purpose.

### II. TECHNICAL FIELD

The present invention generally relates to the field of wireless communications and, more particularly, to a system for communication channel link adaptation.

### III. BACKGROUND INFORMATION

The demand for high rate transmission has rapidly increased in wireless communication systems. Conventional systems may use a large number of redundant bits to assure successful data transmissions in bad channels. However, those systems cannot use the spectrum efficiently because they waste capacity when channel conditions are good. For high rate data applications, techniques of packet switching, dynamic resource assignment and link adaptation may be more suitable than conventional techniques such as circuit switching, fixed resource allocation and fixed transmission schemes.

In a typical wireless communication environment, a transmitter and receiver are surrounded by objects which reflect and scatter transmitted energy, causing transmitted signals to arrive at the receiver via different routes and at different times. This is multipath propagation. If there is a single direct path along which signals are received, along with multipath energy from local scatters, then the situation is called line-of-sight (LOS) propagation. If the direct path from the transmitter to receiver is blocked by buildings, walls, and etc., the signal propagation is termed as non-line-of-sight (NLOS) propagation. The NLOS component is signals received from the transmitter composed of random multipath signals, resulting in Rayleigh distributed amplitude.

Link adaptation, also called an adaptive coding and modulation (ACM), has been implemented in wireless systems to adapt to propagation conditions. Link adaptation is a continuous process in which the attributes of each link within a communications system is dynamically updated to maximize throughput (or some other parameter), so that the available bandwidth is more efficiently utilized according to a set of criteria.

A link adaptation scheme may include a set of modes, each incorporating a different modulation and coding scheme, or some other link parameter for controlling the data rate. Each mode and corresponding modulation and coding scheme has an associated set of performance attributes. Such a link adaptation scheme provides for selecting parameters including transmit power or modulation mode according to the status of channels in a wireless communication environment, and maintaining throughput. Link adaptation schemes can improve rate of transmission, and/or bit error rates, by exploiting channel information that is present at the transmitter.

Signal and protocol parameters change as channel conditions change. Link adaptation schemes serve to adaptively adjust channel transmission formats in response to such changes in channel condition. Link adaptation may be implemented on the network layer or physical layer utilizing feedback information from the receiver. Parameters, such as the transmitting power, modulation level, symbol rate, and coding rate, etc., can be adjusted according to the current channel conditions in accordance with a link adaptation scheme.

Presently, link adaptation systems determine channel condition by selecting transmission formats based on parameters related to certain common channel quality. Link adaptation is performed based on feedback of an indicator of the determined certain common channel quality, such as SINR (Signal to Interference plus Noise Ratio). Conventionally, the transmitter feedbacks the SINR estimate to the receiver for link adaptation and channel quality assessment. However, such conventional approaches do not utilize Rician k-factor to determine channel condition in link adaptation systems.

### SUMMARY

The present invention implements a method and system of a link adaptation based on a Rician k-factor of a channel between a transmitter and a receiver for data transmission in a wireless communication system. In one embodiment, a wireless communication system with link adaptation is provided. The wireless communication system may include a channel k-factor estimator estimating a Rician k-factor of a channel based on a signal received from a transmitter, a frequency band grouping unit determining a size of frequency band grouping based on the Rician k-factor, a transmission mode selector determining a transmission mode for each frequency band group based on the Rician k-factor, and a modulation and coding scheme selector determining a modulation and coding scheme for the each frequency band group.

In another embodiment, a wireless communication receiver with link adaptation is provided. The wireless communication receiver may include a channel estimator determining channel information of a channel between the receiver and a transmitter to feedback to the transmitter, a processing device configured to generate feedback information based on the channel information identifying channel condition, and an output device for providing the feedback information to the transmitter feedback information comprising a Rician k-factor.

In another embodiment, a wireless communication transmitter with link adaptation is provided. The wireless communication transmitter may include an input interface for receiving feedback information on a channel between the transmitter and a receiver from the receiver, a processing device configured to select at least one of a frequency band group and a transmission mode, and a transmitting device configured to transmit data according to at least one of the frequency band group and the transmission mode.

In another embodiment, a link adaptation method based on a Rician k-factor of a channel between a transmitter and a receiver for data transmission is provided in a wireless communication system. The link adaptation method may include estimating by the receiver the Rician k-factor of the channel, determining a size of frequency band grouping based on the Rician k-factor, selecting by the receiver a transmission mode for each of the frequency band group based on the Rician k-factor, selecting by the receiver a modulation and coding scheme for the each frequency band group, and transmitting by the receiver feedback information including the Rician k-factor back to the transmitter.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one (several) embodiment(s) of the invention and together with the description, serve to explain the principles of the invention. In the drawings:

FIG. 1 is a block diagram illustrating a wireless communication with link adaptation;

FIG. 2a illustrates a graph of single-input single-output (SISO) bits error rate (BER) performance of LOS channel for Quadrature Phase Shift Keying (QPSK);

FIG. 2b illustrates a graph of SISO BER performance of LOS channel for 16QAM (Quadrature amplitude modulation);

FIG. 2c illustrates a graph of SISO BER performance of LOS channel for 64QAM;

FIG. 3a illustrates a graph of Vertical-Bell Laboratories-Layered-Space-Time (VBLAST) BER performance of LOS channel for QPSK;

FIG. 3b illustrates a graph of VBLAST BER performance of LOS channel for 16QAM;

FIG. 3c illustrates a graph of VBLAST BER performance of LOS channel for 64QAM;

FIG. 4 is an exemplary table showing details of a relationship between a transmission mode and a k-factor;

FIG. 5 illustrates a graph of channel frequency responses of multi-path channels with different k-factors;

FIG. 6 illustrates an example of a flow diagram of a wireless communication system receiver consistent with an embodiment of the invention;

FIG. 7 illustrates an example of a flow diagram for a wireless communication system transmitter consistent with an embodiment of the invention;

FIG. 8 is a block diagram illustrating wireless communication with link adaptation including feedback of effective SINR;

FIG. 9 illustrates a table of channel frequency responses of multi-path channels with different k-factors; and

FIG. 10 is a block diagram illustrating wireless communication with link adaptation including feedback comprising transmission scheme information.

### DETAILED DESCRIPTION

In the following description, for purposes of explanation and not limitation, specific techniques and embodiments are set forth, such as particular sequences of steps, interfaces and configurations, in order to provide a thorough understanding of the techniques presented herein. While the techniques and embodiments will primarily be described in context with the accompanying drawings, those skilled in the art will further appreciate that the techniques and embodiments may also be practiced in other network types.

Reference will now be made in detail to present embodiments of the invention, examples of which are illustrated in the accompanying drawings. Wherever possible, the same reference numbers will be used throughout the drawings to refer to the same or like parts. While several exemplary embodiments are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

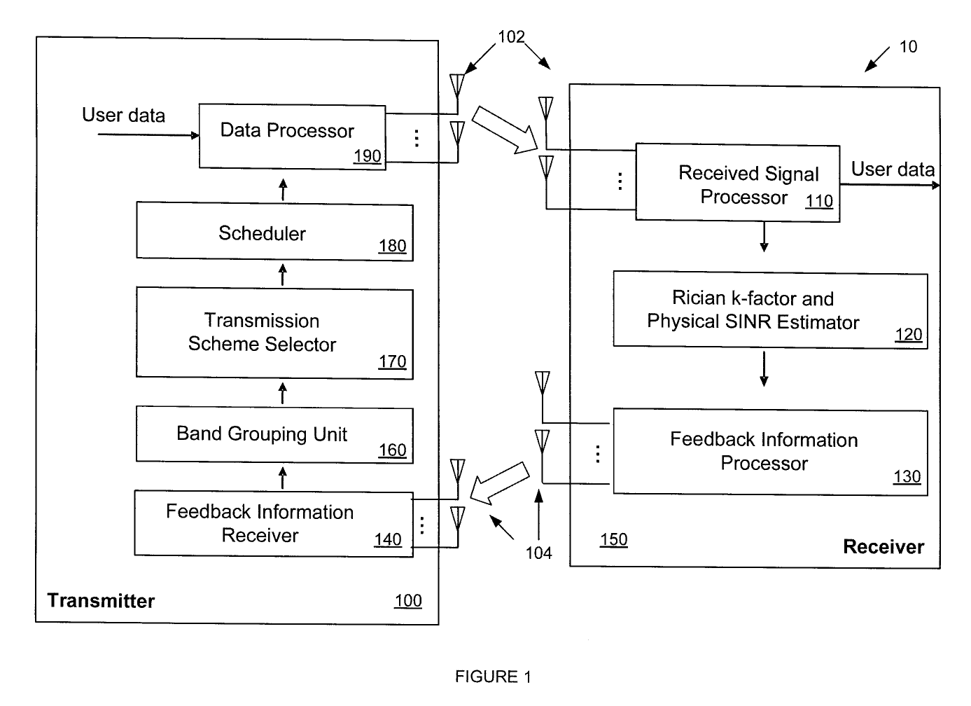

FIG. 1 is a schematic of an exemplary wireless communication system according to an embodiment of the present invention. Wireless communication system 10 illustrates wireless communication using link adaptation, for transmitting data within a set of individual assets, in accordance with one or more disclosed embodiments. Wireless system 10 includes a transmitter 100 and a receiver 150.

In wireless communication system 10, an LOS component may exist between the transmitter 100 and the receiver 150. More particularly, as noted previously, a received signal may include a random multipath component. The amplitude of the received signal may be characterized by a Rayleigh distribution plus a coherent LOS component that has essentially constant power. The power of the LOS component is typically not considered as significantly affecting the Rayleigh distribution until it becomes greater than the total multipath power. A channel having two fundamental components comprised of a fixed component and a fluctuating multipath component, i.e., the addition of several scattered versions of the original signal, can be characterized as having a propagation environment that is Rician in statistical nature. A Rician fading channel is considered a good approximation of the LOS component. In a Rician fading channel, a received signal R is composed of direct wave C and scattered wave S, as follows:

R=C+S. (1)

A power density function of a Rician fading channel can be expressed in terms of a parameter k, known as the Rician k-factor. The k-factor of a Rician channel is the ratio of the power received in a signal component received along a direct path, to the total power received via indirect scattered paths, indicating the strength of an LOS component. The Rician k-factor can be defined as:

$$k = \frac{Power in constant part}{Power in random part} = \frac{{s}^{2} / 2}{{σ}^{2}} = \frac{{s}^{2}}{2 {σ}^{2}} \qquad ( 2 )$$

where s is the amplitude of the coherent component, σ² is the variance of either of the real or imaginary terms of the random multipath component.

The Rician k-factor may be estimated from a set of different samples of the channels, for instance at different frequencies. When k is zero, a Rician distribution reduces to the Rayleigh distribution, and for very large values of k, the component of the direct wave received along a direct path dominates the transmission performance. As k approaches to infinity, the physical situation approaches one in which there is only a single LOS path and no other scattering.

The Rician k-factor thus serves to specify a channel's frequency-selective nature. Knowledge of the Rician k-factor facilitates an understanding of fixed and other types of wireless channels. The Rician k-factor also provides useful information to provide efficient power control. Measurements of the Rician k-factor can be made by way of a network analyzer that compares transmitted and received waveforms. Field technicians can use Rician k-factor readings to estimate the condition of a channel, and to determine the bit error rate of the channel. Therefore, the Rician k-factor is an indicator for channel status and can be used for link adaptation.

Transmitter 100 may represent a base station or a mobile user, while receiver 150 may represent a mobile user or a base station. Transmitter 100 communicates with receiver 150 via communications antennas 102 and 104. As illustrated in FIG. 1, antennas 102(104) are used for transmission (reception) by transmitter 100 and reception (transmission) by receiver 150. Receiver 150 includes a received signal processor 110 configured to process received signals, a Rician k-factor and physical SINR (Signal-to-Interference-plus-Noise-Ratio) estimator 120 and a feedback information processor 130. Rician k-factor and physical SINR estimator 120 is configured to calculate the Rician k-factor and SINR value of the signal received from received signal processor 110 and provides this information to feedback information processor 130. Then, feedback information processor 130 may condition the feedback information and transmit such configured information to transmitter 100 via antenna 104. Transmitter 100 contains a feedback information receiver 140, a band grouping unit 160, a transmission scheme selector 170, a scheduler 180 and a data processor 190. Feedback information receiver 140 is coupled to receive via antenna 104 the data transmitted by feedback information processor 130. The data received by feedback information receiver 140 is sent to band grouping unit 160, which identifies sizes of frequency band grouping for different modulation and coding schemes. Modulation and coding schemes that can potentially be applied can be one of different modulation and coding schemes including Quadrature Amplitude Modulation (QAM) or Phase Shift Keying (PSK) Schemes. Other modulation and coding schemes, however, may also be used. From band grouping unit 160, data is sent to transmission scheme selector 170, which determines the transmission mode of the data received from band grouping unit 160 and provides the result of its determination to scheduler 180. Then, scheduler 180 performs frequency and/or time dependent scheduling and provides the result to data processor 190, which transmits the data to receiver 150.

Wireless communication system 10 utilizes a transmission scheme that adapts to channel conditions according to the calculated Rician k-factor, while the SNR (signal-to-noise ratio) of a signal received via the channel reaches certain levels with small dynamic range. A bit error rate (BER) or packet error rate (PER) may also be considered in order to evaluate the performance in order to adapt proper parameters including transmit power or modulation mode according to the status of channels in a wireless communication system 10. The PER can be determined by:

PER=1−(1−BER)^{N} (3)

where N is the number of bits in the transmitted packet and (1−BER)^{N} is a correlation probability of each packet. To evaluate error probability performance as a function of different channel conditions such as non-line-of-sight (NLOS) and line-of-sight (LOS), wireless communication system 10 according to methods consistent with present embodiments, utilizes a Rician k-factor estimator, such as Rician k-factor and physical SINR estimator 120, to determine the channel condition. The determined channel condition is then utilized to determine which kind of transmission method may be appropriate. Rician k-factor and physical SINR estimator 120 determines the Rician k-factor that indicates the channel conditions. The determined Rician k-factor increases with increasing power of an LOS component in the channel. For a very large Rician k-factor, the LOS component dominates the transmission performance of the channel, very little fading is encountered, and the channel reverts to an additive white Gaussian noise (AGWN) behavior. When the Rician k-factor is larger, wireless communication system 10 may use a coding scheme with higher code-rate and a higher level modulation scheme with higher transmission power, by which the transmission rate can be increased. Conversely, a lower code-rate convolution code and lower level modulation scheme may be used to maintain basic communication quality when the Rician k-factor is smaller.

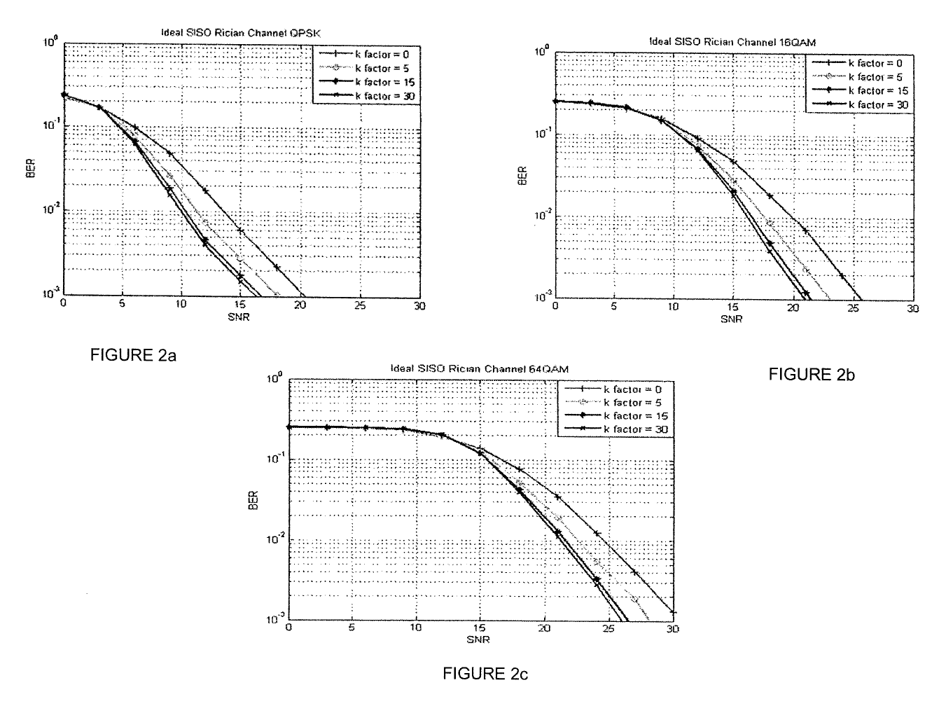

FIGS. 2a, 2b, and 2c illustrate BER performance of a Rician channel for three different modulation schemes: QPSK, 16QAM and 64 AQM, respectively, in a single-input single-output (SISO) transmission mode. As shown in these three diagrams of a system in a SISO transmission mode, when the Rician k-factor increases, the SNR decreases at a fixed BER value. Therefore, channels with higher Rician k-factors are more desirable in the SISO transmission mode since the channels with higher Rician k-factors measure lower SNR values, illustrating a better performance.

Further, comparing three diagrams, the SISO transmission mode achieves a BER value of 10⁻³ when SNR is measured at 17.5 dB, 22.5 dB and 28 dB for QPSK, 16QAM and 64QAM, respectively, with a Rician k-factor of 5. Since QPSK has the lowest SNR measurement compared to the other transmission modes at a constant Rician k-factor, wireless communication system 10 identifies QPSK as the best transmission method for the SISO transmission mode using the channel's Rician k-factor value.

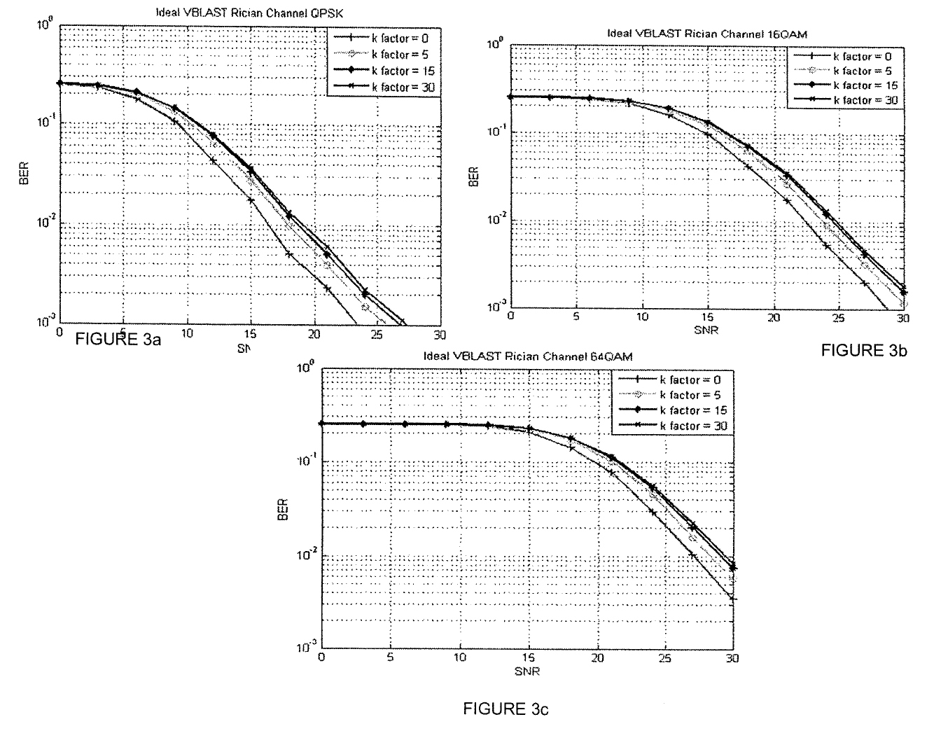

FIGS. 3a, 3b and 3c illustrate BER performance of a Rician channel for QPSK, 16 AQM and 64QAM, respectively, in a multi-input multi-output (MIMO) system. In these figures, a VBLAST (Vertical-Bell Laboratories-Layered-Space-Time) transmission mode is used for the MIMO system. As shown in these figures, when the Rician k-factor decreases, the SNR decreases at a fixed BER value. Therefore, channels with lower Rician k-factors are more desirable in the MIMO transmission mode since the channels with lower Rician k-factors measure lower SNR values, illustrating a better performance.

Rician k-factor may be used for transmission mode selection. For example, comparing FIGS. 3a, 3b and 3c, the MIMO transmission mode achieves a BER value of 10⁻² when SNR is measured at 17.5 dB, 22.5 dB and 28 dB for QPSK, 16QAM and 64QAM, respectively, with a Rician k-factor of 5. When these results are compares with the measurements of the SISO transmission mode, same SNR values at the same Rician k-factor are achieved at different BER values. MIMO achieved a BER value of 10⁻² whereas SISO achieved a BER value of 10⁻³. That is, for a channel with a relatively small k-factor, the SISO transmission mode may be selected.

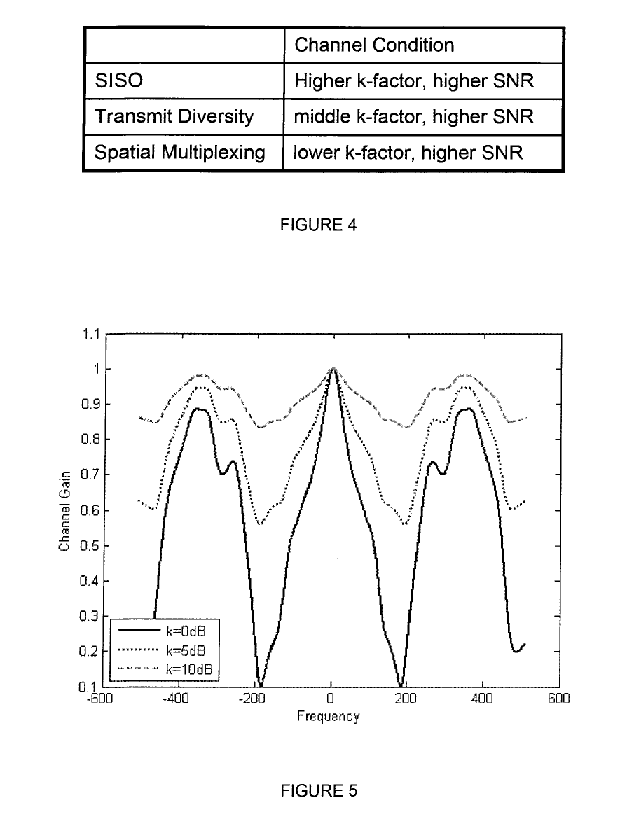

FIG. 4, illustrates a table of transmission modes for selection based on SINR and Rician channel k-factor. Transmit diversity represents a transmission mode using signals that originate from two or more independent sources that have been modulated with identical information-bearing signals that may vary in their transmission characteristics at any given time. Spatial multiplexing is a transmission technique in MIMO wireless communication to transmit independent and separately encoded data signals from each of the multiple transmit antennas. As shown in FIG. 4, a wireless communication system may identify the best transmission mode that would suite the given channel condition of the system. For example, a channel with higher Rician k-factor, and higher SNR may use the SISO transmission mode. For a channel with middle k-factor and higher SNR, transmit diversity may be identified as the most suitable transmission mode. For a channel with lower Rician k-factor, but higher SNR, spatial multiplexing method of MIMO mode may be the best match.

In addition to transmission mode selection, the Rician k-factor may also be used as an indicator for channel flatness across a band, measuring the power variations in peak and valley values. FIG. 5 illustrates exemplary channel frequency responses of multi-path channels with different Rician k-factors in an LOS system. Greater k-factor implies that the LOS component dominates the signal transmission, such that the channel is relative flat compared to the channels with lower k-factors. Therefore, the Rician k-factor can also be used to determine the size of band grouping that uses the same transmission mode. For example, if the Rician k-factor approaches infinity or a substantially large value, the channel frequency response is flat, i.e. the channel is invariant for all the frequency bands, the same modulation and coding scheme can be applied to all the frequency bands since there is only one group of channels. Furthermore, regarding the overhead of channel feedback, the Rician k-factor may also be used to reduce the feedback overhead if the channel is relative flat. If the Rician k-factor is small, indicating the channel is variant in frequency domain, the receiver needs to feedback the channel information on a frequency-by-frequency basis, that is, channel information of multiple channels or multiple groups of channels. On the other hand, if the Rician k-factor is large, indicating the channel is invariant in frequency domain, the receiver may only feedback channel information of one channel or one group of channels.

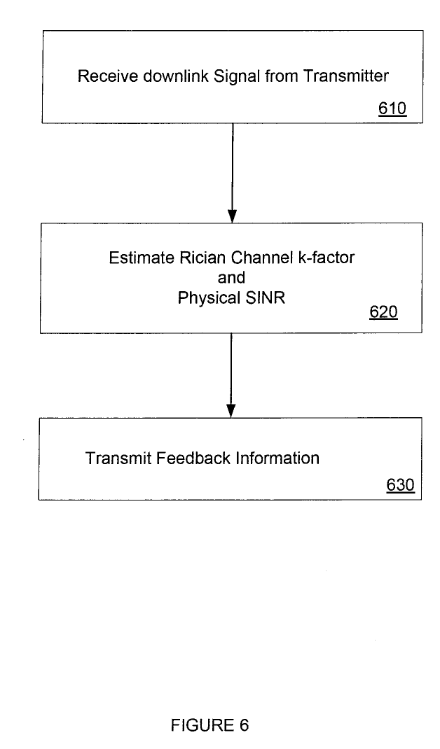

Now, the operation of the wireless communication system 10 will be described as follows. Respective functions and the corresponding operation of the receiver 150 are described first. FIG. 6 illustrates an exemplary receiver procedure. In step 610, the receiver 150 receives a downlink signal from transmitter 100. Further, the receiver 150 estimates the Rician channel k-factor and physical SINR based on the signal received from the transmitter 100 in step 620, using previously described methods of estimating the Rician k-factor and SINR. The receiver 150 determines channel information needed to feedback to the transmitter 100. The feedback information includes information such as k-factor, channel information, SNR, SINR, etc., or combination of two or more thereof. Finally, in step 630, the receiver 150 transmits the feedback information to the transmitter 100.

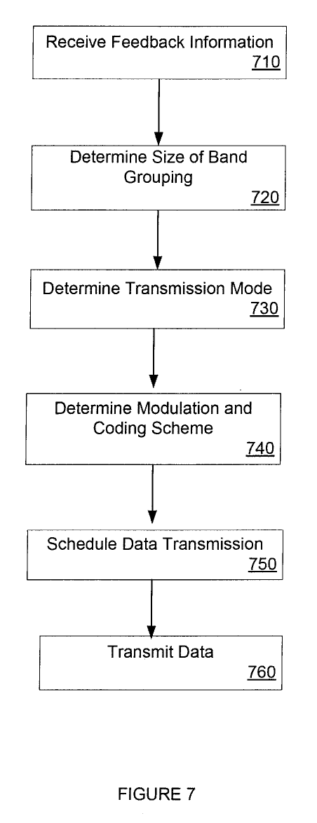

Respective functions and the corresponding operation of the transmitter 100 are described next. FIG. 7 illustrates an exemplary transmitter procedure. Upon receiving input data along with the feedback information from the receiver 150 in step 710, the transmitter 100 determines the size of the frequency band grouping in step 720. A channel with greater k-factor may imply that the coherent bandwidth is larger, and the frequency band may be grouped in a larger size. A channel with smaller k-factor may imply that the coherent bandwidth is narrower, and the frequency band may be grouped in a smaller size. After step 720 is completed, the transmitter 100 determines the transmission mode, such as SISO, transmit diversity and spatial multiplexing, etc., for each band group in step 730. Further, the transmitter 100 determines the modulation and coding scheme for each band group in step 740. Finally, the transmitter 100 schedules the data and transmits them to the receiver 150 in steps 750 and 760, respectively.

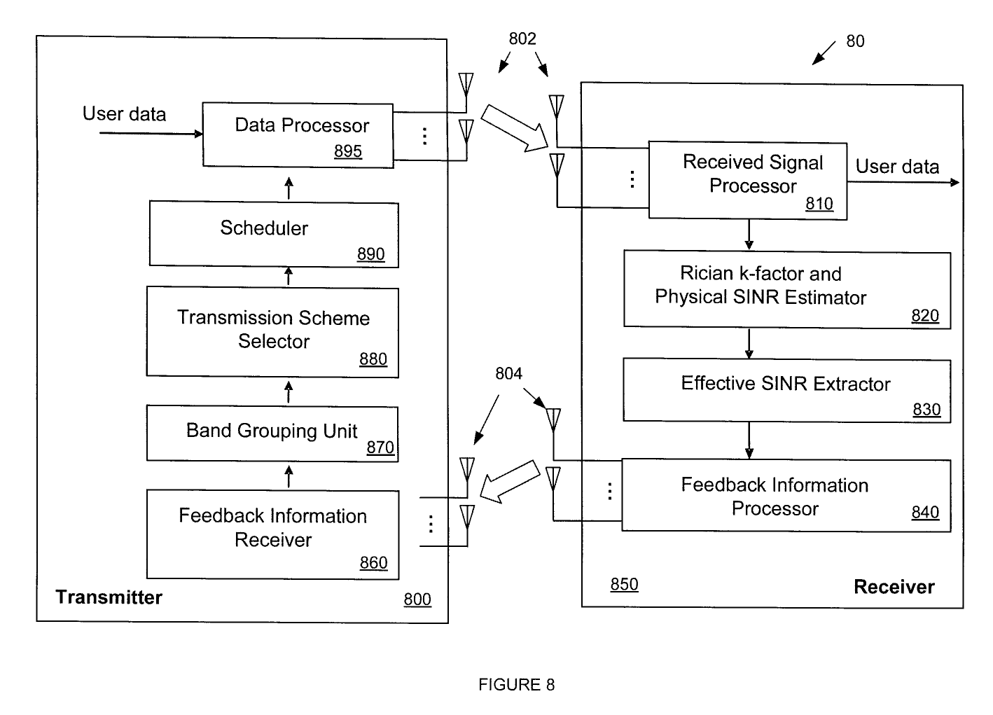

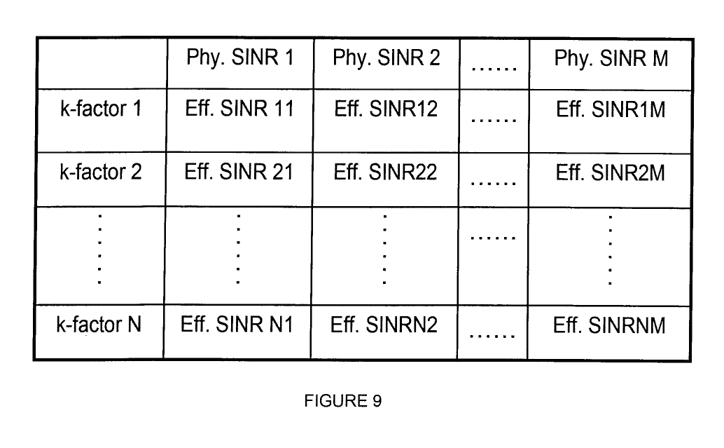

FIG. 8 presents another embodiment of a wireless communication with link adaptation of FIG. 1. Receiver 850 of wireless system 80 in FIG. 8 is similar to receiver 150 shown in FIG. 1. Receiver 850 includes a received signal processor 810, a Rician k-factor and physical SINR estimator 820 and a feedback information processor 840, which are similar to the received signal processor 110, Rician k-factor and physical SINR estimator 120 and feedback information processor 130, described above. However, in addition to what is shown in FIG. 1, an effective SINR extractor 830 is provided to determine the effective SINR of the channel and update the feedback information to include the effective SINR component. The effective SINR extractor 830 in receiver 850 extracts the effective SINR based on physical SINR and Rician k-factor received from Rician k-factor and physical SINR estimator 820. The extraction of effective SINR may be performed by using a pre-defined table as shown in FIG. 9, or by using online calculations. For example, as shown in FIG. 9, an effective SINR, as denoted as Eff. SINR NM, where N is the number of rows of k-factors and M is the number of columns of physical SINR, may be determined by a k-factor N and a physical SINR M.

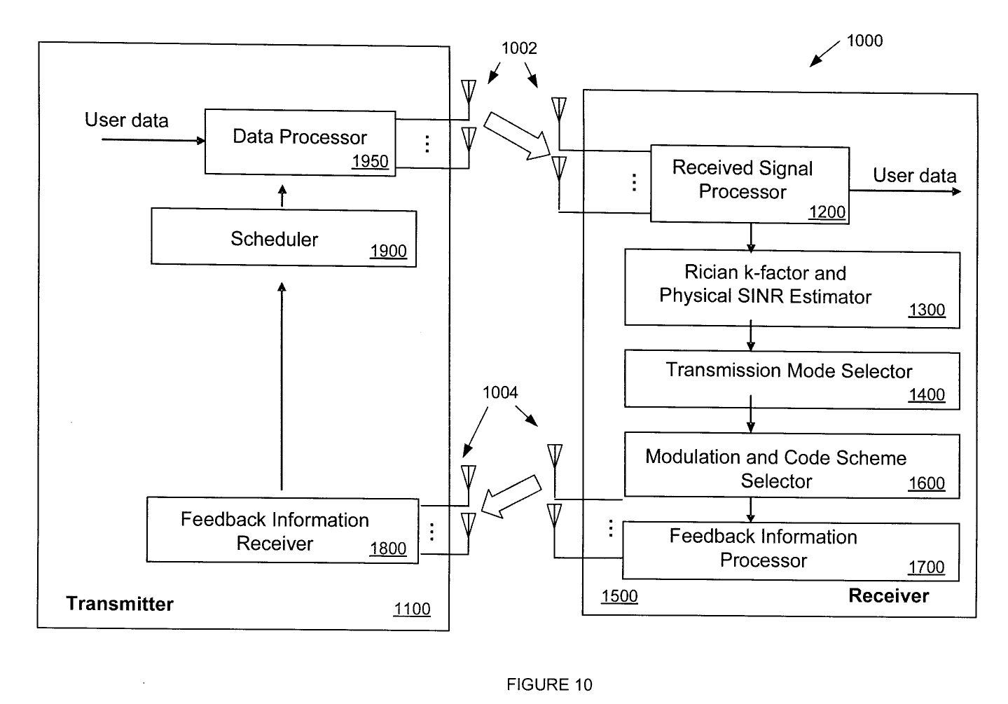

In another embodiment, as illustrated in FIG. 10, a wireless communication system uses a proposed link adaptation with a feedback index including transmission scheme information. The feedback information of system 1000 in FIG. 10 includes an index of transmission scheme instead of quantified effective SINR, as disclosed in FIG. 9, to reduce feedback overhead. Receiver 1500 of system 1000 includes a received signal processor 1200, a Rician k-factor and physical SINR estimator 1300 and a feedback information processor 1700. Moreover, receiver 1500 has a transmission mode selector 1400 and a modulation and code scheme selector 1600. In system 1000, transmission mode selection and modulation and coding scheme selection are performed in receiver 1500. Based on the Rician k-factor and physical SINR value estimated by Rician k-factor and physical SINR estimator 1300, transmission mode selector 1400 and a modulation and code scheme selector 1600 can make a selection of modulation and code scheme and transmission mode such as SISO, transmit diversity or spatial multiplexing. Then, receiver 1500 feedbacks the index of transmission scheme instead of quantified effective SINR to transmitter 1100. An example of index of transmission scheme is shown below in Table 1.

TABLE 1
INDEX OF TRANSMISSION SCHEME

| Index | Channel Condition/Transmission Scheme |
|---|---|
| 1 | Higher k-factor, higher SNR/Using SISO transmission scheme |
| 2 | Middle k-factor, higher SNR/Using Transmit Diversity |
| 3 | Lower k-factor, higher SNR/Using Spatial Multiplexing |

As shown in Table 1, both transmitter 1100 and receiver 1500 include a table of a list of indices corresponding to particular channel information. For example, index ‘1’ corresponds to channel information indicating a higher k-factor, higher SNR and using SISO transmission scheme; index ‘2’ corresponds to channel information indicating a middle k-factor, higher SNR and using transmit diversity; and index ‘3’ corresponds to channel information indicating a lower k-factor, higher SNR and using spatial multiplexing. Receiver 1500 may feedback the index instead of the particular channel information. Because transmitter 1100 also includes the same table, transmitter 1100 may apply the transmission scheme according to the feedbacked index or indices. The index may also be sent together with other feedback information or channel information.

Upon receiving input data along with the feedback information from the receiver 1500 by feedback information receiver 1800, the transmitter 1100 schedules the data and transmits them to the receiver 1500 by scheduler 1900 and data processor 1950, respectively.

Although the disclosed modules have been described above as being separate modules, one of ordinary skill in the art will recognize that functionalities provided by one or more modules may be combined. As one of ordinary skill in the art will appreciate, one or more of modules may be optional and may be omitted from implementations in certain embodiments.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations may be implemented in a software, hardware, or a combination of hardware and software. Examples of hardware include computing or processing systems, such as personal computers, servers, laptops, mainframes, and micro-processors.

What is claimed is:

1. A wireless communication system with link adaptation, comprising:
a channel k-factor estimator estimating a Rician k-factor of a channel based on a signal received from a transmitter;
a frequency band grouping unit determining a size of frequency band grouping based on the Rician k-factor;
a transmission mode selector determining a transmission mode for each frequency band group based on the Rician k-factor; and
a modulation and coding scheme selector determining a modulation and coding scheme for the each frequency band group.

2. The system of claim 1, wherein the Rician k-factor indicates status of the channel.

3. The system of claim 1, wherein a data transmission mode of the system comprises at least one of a single-input single-output (SISO) mode, a transmit diversity mode, and a multiple-input multiple-output (MIMO) mode.

4. The system of claim 1, wherein the frequency band grouping unit determines size of frequency band that uses the same transmission mode and modulating and coding scheme.

5. A wireless communication receiver with link adaptation, comprising:
a channel estimator determining channel information of a channel between the receiver and a transmitter to feedback to the transmitter;
a processing device configured to generate feedback information based on the channel information identifying channel condition; and
an output device for providing the feedback information to the transmitter feedback information comprising a Rician k-factor.

6. The receiver of claim 5, wherein the feedback information includes at least one of the Rician k-factor channel information, a signal-to-noise-ratio, and a signal-to-interference-plus-noise-ratio.

7. A wireless communication transmitter with link adaptation, comprising:
an input interface for receiving feedback information on a channel between the transmitter and a receiver from the receiver;
a processing device configured to select at least one of a frequency band group and a transmission mode; and
a transmitting device configured to transmit data according to at least one of the frequency band group and the transmission mode.

8. The transmitter of claim 7, wherein the feedback information includes at least one of a Rician k-factor channel information, a signal-to-noise-ratio, and a signal-to-interference-plus-noise-ratio.

9. The transmitter of claim 7, wherein the processing device selects a larger coherent bandwidth for a channel with a greater Rician k-factor.

10. The transmitter of claim 7, wherein the transmission mode comprises at least one of a single input single output (SISO) mode, a transmit diversity technique, and a spatial multiplexing technique.

11. The transmitter of claim 7, further comprising a transmission scheduler for scheduling the data for transmission.

12. The transmitter of claim 7, wherein the processing device further selects a modulation and coding scheme for each frequency band group.

13. A link adaptation method based on a Rician k-factor of a channel between a transmitter and a receiver for data transmission in a wireless communication system, comprising:
estimating by the receiver the Rician k-factor of the channel;
determining a size of frequency band grouping based on the Rician k-factor;
selecting by the receiver a transmission mode for each of the frequency band group based on the Rician k-factor;
selecting by the receiver a modulation and coding scheme for the each frequency band group; and
transmitting by the receiver feedback information including the Rician k-factor back to the transmitter

14. The method of claim 13, wherein the transmission mode includes at least one of a single-input single-output (SISO) transmission mode, a transmit diversity technique, and a spatial multiplexing technique.
